(19) United States
(12) Patent Application Publication
(10) Pub. No.: US 2023/0112747 A1
(43) Pub. Date: Apr. 13, 2023

(54) METHOD FOR ALLOCATING RESOURCE FOR STORING VISUALIZATION INFORMATION, APPARATUS, AND SYSTEM

(71) Applicant: HUAWEI TECHNOLOGIES CO., LTD., Shenzhen (CN)

(72) Inventors: Chao HUANG, Beijing (CN); Nan LI, Beijing (CN)

(73) Assignee: HUAWEI TECHNOLOGIES CO., LTD., Shenzhen (CN)

(21) Appl. No.: 17/903,227

(22) Filed: Sep. 6, 2022

(30) Foreign Application Priority Data
Sep. 30, 2021 (CN) 202111160775.1

(51) Int. Cl. H04L 49/9005; H04L 47/70; H04L 49/90

(52) U.S. Cl. CPC H04L 49/9005; H04L 47/82; H04L 49/9084

(57) ABSTRACT

A method for allocating a resource for storing visualization information, an apparatus, and a system are provided. The method includes: a first network device determines a first queue based on a constraint condition, where the first queue is a queue that needs to be visualized. Then, the first network device allocates a first storage resource to the first queue, where the first storage resource is used to store visualization information of the first queue, and the visualization information is information used to visualize the first queue. Therefore, occupation of storage resources in the first network device is reduced.

### CROSS-REFERENCE TO RELATED APPLICATION

This application claims priority to Chinese Pat. App. No. 202111160775.1, filed on Sep. 30, 2021, which is hereby incorporated by reference in its entirety.

### TECHNICAL FIELD

The embodiments relate to the field of communication technologies, a method for allocating a resource for storing visualization information, an apparatus, and a system.

### BACKGROUND

In the field of automatic network O&M, a network device sends collected visualization information to an analysis platform. The analysis platform uses manual experience or artificial intelligence (AI) algorithms to comprehensively analyze and visualize the visualization information, so that automatic network management and O&M are implemented. These embodiments may be applied to areas such as a network exception alarm, topology management, congestion management, a capacity expansion alarm, and service exception analysis.

In a process in which the network device collects the visualization information, a storage resource is allocated to each information collection unit to store visualization information of the unit. In an example of queue management, the network device allocates a storage resource to each queue to store visualization information of the queue. A storage resource that needs to be occupied by the visualization information stored by the network device is in direct proportion to a quantity of queues. The foregoing implementation causes a waste of storage resources of the network device.

### SUMMARY

In view of this, the embodiments may provide a method for allocating a resource for storing visualization information, an apparatus, and a system. A first network device determines a first queue based on a constraint condition, where the first queue is a queue that needs to be visualized. Then, the first network device allocates a first storage resource to the first queue, where the first storage resource is used to store visualization information of the first queue, and the visualization information is information used to visualize the first queue. Therefore, occupation of storage resources in the first network device is reduced.

According to a first aspect, a method for allocating a resource for storing visualization information is provided. The method includes: A first network device determines a first queue based on a constraint condition, where the first queue is a queue that needs to be visualized. Then, the first network device allocates a first storage resource to the first queue, where the first storage resource is used to store visualization information of the first queue, and the visualization information is information used to visualize the first queue.

Based on the solution provided in this embodiment, in an actual network scenario, the first network device determines the first queue based on the constraint condition, and then the first network device allocates the first storage resource to the first queue. Therefore, a large amount of useless visualization information in the first network device is not stored, and storage resources for storing the useless visualization information are not allocated, so that occupation of storage resources in the first network device is reduced.

In a possible implementation of the first aspect, the constraint condition includes a first constraint condition, the first constraint condition is that a queue length is greater than a first threshold, and that a first network device determines a first queue based on a constraint condition includes: The first network device determines, based on the first constraint condition, that a queue length of the first queue is greater than the first threshold.

In another possible implementation of the first aspect, the constraint condition includes a first constraint condition, the first constraint condition is that a packet loss rate is greater than a first threshold, and that a first network device determines a first queue based on a constraint condition includes: The first network device determines, based on the first constraint condition, that a packet loss rate of the first queue is greater than the first threshold.

In still another possible implementation of the first aspect, the constraint condition includes a first constraint condition, the first constraint condition is that an enqueue rate is greater than a first threshold, and that a first network device determines a first queue based on a constraint condition includes: The first network device determines, based on the first constraint condition, that an enqueue rate of the first queue is greater than the first threshold.

In still another possible implementation of the first aspect, the constraint condition includes a first constraint condition, the first constraint condition is that a dequeue rate is greater than a first threshold, and that a first network device determines a first queue based on a constraint condition includes: The first network device determines, based on the first constraint condition, that a dequeue rate of the first queue is greater than the first threshold.

In still another possible implementation of the first aspect, the constraint condition includes a first constraint condition, the first constraint condition is that a service type of traffic in a queue is a specified service type, and that a first network device determines a first queue based on a constraint condition includes: The first network device determines, based on the first constraint condition, that a service type of traffic in the first queue is the specified service type.

Optionally, the constraint condition further includes a second constraint condition, the second constraint condition is that a queue number is equal to a specified queue number, and that a first network device determines a first queue based on a constraint condition includes: The first network device determines, based on the second constraint condition, that a queue number of the first queue is equal to the specified queue number.

Optionally, the visualization information of the first queue includes at least one of the following information: the queue length, the packet loss rate, the enqueue rate, and the dequeue rate.

Optionally, the first queue is an egress queue of the first network device, the visualization information of the first queue further includes first configuration information, and the first configuration information is configuration information that is configured by the first network device on the first queue and that is used to manage the egress queue.

Optionally, the first queue is an ingress queue of the first network device, the visualization information of the first queue further includes first configuration information, and the first configuration information is configuration information that is configured by the first network device on the first queue and that is used to manage the ingress queue.

In a possible implementation of the first aspect, the first network device generates a first packet, where the first packet includes the visualization information of the first queue. The first network device sends the first packet to a second network device.

In another possible implementation of the first aspect, the first network device obtains the visualization information of the first queue based on the first storage resource. The first network device outputs the visualization information of the first queue.

According to a second aspect, a method for allocating a resource for storing visualization information is provided. The method includes: A second network device receives a first packet sent by a first network device, where the first packet includes visualization information of a first queue, the first queue is a queue that is determined by the first network device based on a constraint condition and that needs to be visualized, and the visualization information is information used to visualize the first queue. The second network device outputs the visualization information of the first queue.

Optionally, the constraint condition includes a first constraint condition, and the first constraint condition includes at least one of the following conditions: a queue length is greater than a first threshold, a packet loss rate is greater than a first threshold, an enqueue rate is greater than a first threshold, a dequeue rate is greater than a first threshold, and a service type of traffic in a queue is a specified service type.

Optionally, the constraint condition further includes a second constraint condition, and the second constraint condition is that a queue number is equal to a specified queue number.

According to a third aspect, a first network device is provided. The first network device has a function of implementing behavior of the first network device in the foregoing methods. The function may be implemented based on hardware or may be implemented based on hardware executing corresponding software. The hardware or the software includes one or more modules corresponding to the foregoing function.

A structure of the first network device may include a processor and an interface. The processor is configured to support the first network device in performing a corresponding function in the foregoing methods. The interface is configured to: support communication between the first network device and a second network device; and send information or instructions in the foregoing methods to the second network device or receive information or instructions in the foregoing methods from the second network device. The first network device may further include a memory. The memory is coupled to the processor, and the memory stores program instructions and data that are necessary for the first network device.

The first network device may include a processor, a transmitter, a receiver, a random access memory, a read-only memory, and a bus. The processor is coupled to the transmitter, the receiver, the random access memory, and the read-only memory through the bus. When the first network device needs to be run, the first network device is started by using a basic input/output system built into the read-only memory or a bootloader booting system in an embedded system, to boot the first network device to enter a normal running state. After the first network device enters the normal running state, an application program and an operating system are run in the random access memory, to enable the processor to perform the method in any one of the first aspect or the possible implementations of the first aspect.

According to a fourth aspect, a first network device is provided. The first network device includes a main control board and an interface board and may further include a switching board. The first network device is configured to perform the method in any one of the first aspect or the possible implementations of the first aspect. The first network device may include a module configured to perform the method in any one of the first aspect or the possible implementations of the first aspect.

According to a fifth aspect, a first network device is provided. The first network device includes a controller and a first forwarding subdevice. The first forwarding subdevice includes an interface board and may further include a switching board. The first forwarding subdevice is configured to perform a function of the interface board in the fourth aspect and may further perform a function of the switching board in the fourth aspect. The controller includes a receiver, a processor, a transmitter, a random access memory, a read-only memory, and a bus. The processor is coupled to the receiver, the transmitter, the random access memory, and the read-only memory through the bus. When the controller needs to be run, the controller is started by using a basic input/output system built into the read-only memory or a bootloader booting system in an embedded system, to boot the controller to enter a normal running state. After the controller enters the normal running state, an application program and an operating system are run in the random access memory, to enable the processor to execute a function of the main control board in the fourth aspect.

According to a sixth aspect, a computer storage medium is provided and is configured to store a program, code, or instructions used by the foregoing first network device. When a processor or a hardware device executes the program, the code, or the instructions, functions, or steps of the first network device in the foregoing aspects may be completed.

According to a seventh aspect, a second network device is provided. The second network device has a function of implementing behavior of the second network device in the foregoing methods. The function may be implemented based on hardware or may be implemented based on hardware executing corresponding software. The hardware or the software includes one or more modules corresponding to the foregoing function.

A structure of the second network device may include a processor and an interface. The processor is configured to support the second network device in performing a corresponding function in the foregoing methods. The interface is configured to: support communication between the second network device and a first network device; and send information or instructions in the foregoing methods to the first network device or receive information or instructions in the foregoing methods from the first network device. The second network device may further include a memory. The memory is coupled to the processor, and the memory stores program instructions and data that are necessary for the second network device.

The second network device may include a processor, a transmitter, a receiver, a random access memory, a read-only memory, and a bus. The processor is coupled to the transmitter, the receiver, the random access memory, and the read-only memory through the bus. When the second network device needs to be run, the second network device is started by using a basic input/output system built into the read-only memory or a bootloader booting system in an embedded system, to boot the second network device to enter a normal running state. After the second network device enters the normal running state, an application program and an operating system are run in the random access memory, to enable the processor to perform the method in any one of the second aspect or the possible implementations of the second aspect.

According to an eighth aspect, a second network device is provided. The second network device includes a main control board and an interface board and may further include a switching board. The second network device is configured to perform the method in any one of the second aspect or the possible implementations of the second aspect. The second network device may include a module configured to perform the method in any one of the second aspect or the possible implementations of the second aspect.

According to a ninth aspect, a second network device is provided. The second network device includes a controller and a second forwarding subdevice. The second forwarding subdevice includes an interface board and may further include a switching board. The second forwarding subdevice is configured to perform a function of the interface board in the eighth aspect and may further perform a function of the switching board in the eighth aspect. The controller includes a receiver, a processor, a transmitter, a random access memory, a read-only memory, and a bus. The processor is coupled to the receiver, the transmitter, the random access memory, and the read-only memory through the bus. When the controller needs to be run, the controller is started by using a basic input/output system built into the read-only memory or a bootloader booting system in an embedded system, to boot the controller to enter a normal running state. After the controller enters the normal running state, an application program and an operating system are run in the random access memory, to enable the processor to execute a function of the main control board in the eighth aspect.

According to a tenth aspect, a computer storage medium is provided and is configured to store a program, code, or instructions used by the foregoing second network device. When a processor or a hardware device executes the program, the code, or the instructions, functions, or steps of the second network device in the foregoing aspects may be completed.

According to an eleventh aspect, a communication system is provided. The system includes a first network device and a second network device, the first network device is the first network device in the third aspect, the fourth aspect, or the fifth aspect, and the second network device is the second network device in the seventh aspect, the eighth aspect, or the ninth aspect.

According to the foregoing solutions, the first network device determines the first queue based on the constraint condition, where the first queue is a queue that needs to be visualized. Then, the first network device allocates the first storage resource to the first queue, where the first storage resource is used to store the visualization information of the first queue, and the visualization information is information used to visualize the first queue. Therefore, occupation of storage resources in the first network device is reduced.

### BRIEF DESCRIPTION OF THE DRAWINGS

FIG. 1 is a schematic diagram of a network connection according to an embodiment;

FIG. 2 is a flowchart of visualizing a first queue according to an embodiment;

FIG. 3 is another flowchart of visualizing a first queue according to an embodiment;

FIG. 4 is a schematic diagram of a structure of a first network device according to an embodiment;

FIG. 5 is a schematic diagram of a hardware structure of a first network device according to an embodiment;

FIG. 6 is a schematic diagram of a hardware structure of a first network device according to an embodiment;

FIG. 7 is a schematic diagram of a structure of a second network device according to an embodiment;

FIG. 8 is a schematic diagram of a hardware structure of a second network device according to an embodiment; and

FIG. 9 is a schematic diagram of a hardware structure of a second network device according to an embodiment.

### DETAILED DESCRIPTION OF THE EMBODIMENTS

The following separately provides detailed descriptions by using embodiments.

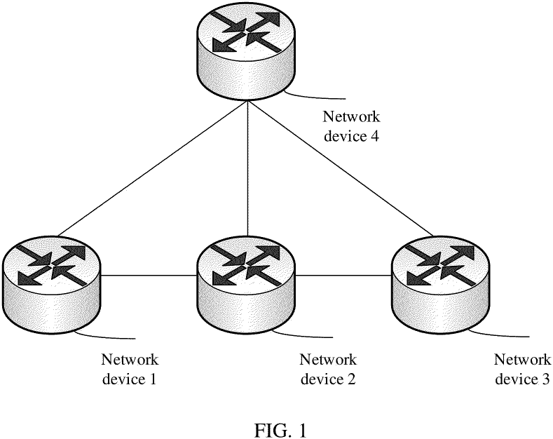

FIG. 1 is a schematic diagram of a network connection according to an embodiment. For example, FIG. 1 relates to a network, including a network device 1, a network device 2, a network device 3, and a network device 4. The network device 1 is connected to the network device 2 through a communication link, the network device 2 is connected to the network device 3 through a communication link, and the network device 4 is connected to the network device 1, the network device 2, and the network device 3 separately through a communication link.

For example, the network shown in FIG. 1 may be used in a data center (DC) network. The data center network includes a top of rack (TOR), and a spine, and further includes a controller. The network device 1 and the network device 3 shown in FIG. 1 correspond to TOR devices of a data center and are respectively a TOR 1 and a TOR 2. The network device 2 shown in FIG. 1 corresponds to a spine device in the data center, and the network device 4 shown in FIG. 1 corresponds to a controller device in the data center. The TOR 1 communicates with the spine through a communication link, the spine communicates with the TOR 2 through a communication link, and the controller device communicates with the TOR 1, the TOR 2, and the spine separately through a communication link.

For example, the network shown in FIG. 1 may be used in an in-situ operation, administration, and maintenance (IOAM) network. The IOAM network includes an ingress node, a transit node, an egress node, and an analyzer. The ingress node corresponds to the network device 1 shown in FIG. 1, the transit node corresponds to the network device 2 shown in FIG. 1, the egress node corresponds to the network device 3 shown in FIG. 1, and the analyzer corresponds to the network device 4 shown in FIG. 1. The ingress node communicates with the transit node through a communication link, the transit node communicates with the egress node through a communication link, and the egress node communicates with the analyzer through a communication link.

The following uses visualization of a queue in the scenario in FIG. 1 as an example to describe an implementation of allocating a resource by a network device. The resource is used to store visualization information of the queue. In this embodiment, traffic is sent from the network device 1 to the network device 2 and then sent to the network device 3. The traffic is stacked in a buffer of a corresponding queue in the network device, and a queue length is a size of a buffer occupied by the stacked traffic that is in the queue. The network device 1, the network device 2, and the network device 3 collect visualization information of queues on respective devices, for example, queue lengths of the queues, and send the collected visualization information to the network device 4. Then, the network device 4 analyzes and outputs the visualization information. That the network device 1 collects visualization information of queues is used as an example. The network device 1 needs to allocate a separate storage resource to each queue to store visualization information of the queue, and the network device 1 then sends the visualization information of the queues to the network device 4. The network device 1 sends the visualization information of all the queues to the network device 4, which occupies a large amount of network bandwidth. After receiving the visualization information, the network device 4 further needs to obtain useful visualization information through filtering. For example, for a network exception alarm, the network device 4 focuses on an abnormal queue in a network, so that the network device 4 filters the visualization information of all the queues to obtain the abnormal queue, for example, a congested queue, namely, a queue whose queue length is greater than a threshold. A manner in which the network device 2 and the network device 3 each collect visualization information of queues is the same as that of the network device 1. Details are not described herein again.

It can be understood from the foregoing described implementation that, the network device 1 allocates a storage resource to each queue and stores a large amount of useless visualization information. Actually, the network device 1 only needs to allocate a storage resource to the congested queue and send visualization information of the congested queue to the network device 4. Consequently, in an existing visualization process, the network device 1 stores the large amount of useless visualization information, and occupies excessive storage resources, which causes a waste of storage resources of the network device 1.

The embodiments may provide an implementation of allocating a resource for storing visualization information. The implementation is applied to the network shown in FIG. 1. An example in which the network device 1 allocates a resource for storing visualization information of a queue is used for description. The implementation may also be applied to the network device 2 and the network device 3, and details are not described herein. The network device 1 determines a first queue based on a constraint condition. The first queue is a queue that needs to be visualized. Then, the network device 1 allocates a first storage resource to the first queue, where the first storage resource is used to store visualization information of the first queue, and the visualization information is information used to visualize the first queue. In other words, the network device 1 allocates the first storage resource to the first queue that meets the constraint condition, to store the visualization information of the first queue.

An example is used to describe the foregoing process. There are four queues in the network device 1, and the four queues are a queue 1, a queue 2, a queue 3, and a queue 4. The network device 1 reads registers corresponding to the four queues, to obtain queue lengths of the four queues that are respectively 2 kilobytes (KB), 5 KB, 8 KB, and 45 KB. The constraint condition is that a queue length is greater than 40 KB. In this case, the first network device may determine, based on the constraint condition, that the queue length 45 KB of the queue 4 is greater than 40 KB, and the queue 4 is a queue that needs to be visualized. The queue lengths of the queue 1, the queue 2, and the queue 3 are respectively 2 KB, 5 KB, and 8 KB, and are all less than 40 KB. The queue 1, the queue 2, and the queue 3 are not queues that need to be visualized. Then, the network device 1 allocates the first storage resource to the queue 4, where the first storage resource is used to store visualization information of the queue 4, and the visualization information is information used by the network device 4 to visualize the queue 4.

Therefore, in the foregoing process, the network device 1 does not store a large amount of useless visualization information, and storage resources for storing the useless visualization information are not allocated, so that occupation of storage resources in the network device 1 is reduced.

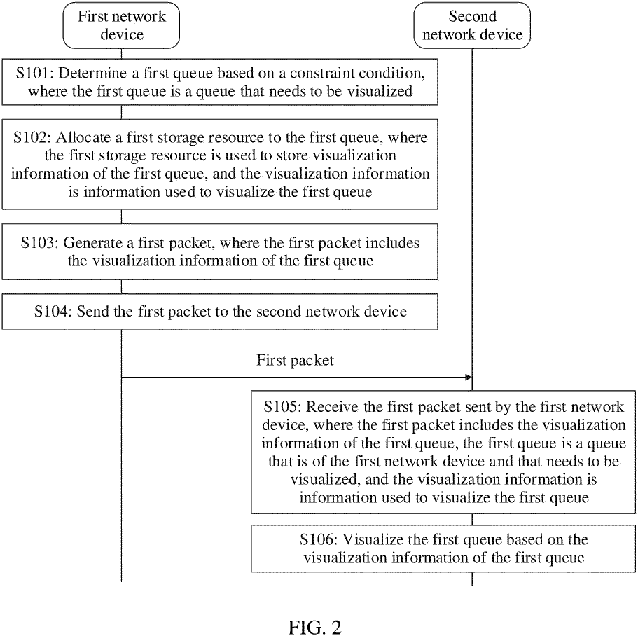

FIG. 2 is a flowchart of visualizing a first queue according to an embodiment. The method shown in FIG. 2 may be applied to the network shown in FIG. 1. In an implementation, an example of allocating a resource for storing visualization information of a queue is used for description. It should be understood that the solutions may also be applied to allocation of a resource for storing visualization information of an item of another type, for example, allocation of a resource for storing visualization information of a port. In this implementation, an example in which a first network device corresponds to the network device 1 in FIG. 1 and a second network device corresponds to the network device 4 in FIG. 1 is used for description. The method of the first network device may also be applied to the network device 2 and the network device 3, and details are not described herein. The method includes S101 to S106 that are as follows.

S101: The first network device determines a first queue based on a constraint condition, where the first queue is a queue that needs to be visualized.

According to the descriptions of the foregoing implementation, in a process of allocating a resource for storing visualization information of a queue, the network device 1 allocates a storage resource to the first queue determined based on the constraint condition. Correspondingly, the network device 1 determines the first queue based on the constraint condition, and the first queue is a queue that needs to be visualized. In other words, the first queue is a queue that meets the constraint condition and is also a queue that needs to be visualized.

In a possible implementation, a first constraint condition is that a queue length is greater than a first threshold, and that the network device 1 determines the first queue based on the constraint condition includes: The network device 1 determines, based on the first constraint condition, that a queue length of the first queue is greater than the first threshold. A manner of obtaining the first threshold that is in the first constraint condition is not limited. The first threshold may be sent by the network device 4 to the network device 1, may be directly configured on the network device 1 by a network management system or a user, or may be obtained based on a default configuration of the network device 1 before delivery. An execution manner in which the network device 1 determines the first queue based on the first constraint condition is not limited. In other words, the network device 1 may first obtain the first constraint condition, then determine whether each queue meets the first constraint condition and determine the first queue if the queue meets the first constraint condition. Alternatively, the network device 1 may first obtain a queue, and then determine whether the queue meets the first constraint condition. Further, the network device 1 may alternatively first obtain the first constraint condition, and then directly determine the first queue based on the first constraint condition. A queue length is a length of a buffer in a queue in the network device 1, and the network device 1 determines, based on the first constraint condition, that the queue length of the first queue is greater than the first threshold. For example, if the first threshold is 20 KB, the first constraint condition is that a queue length is greater than 20 KB. A queue length of a queue 1 is 45 KB, and a queue length of a queue 2 is 5 KB. The network device 1 may determine, based on the first constraint condition, that the queue length 45 KB of the queue 1 is greater than the first threshold 20 KB. Also, a relationship between the queue length and the first threshold is not limited. A first constraint condition that the queue length is less than, less than or equal to, greater than or equal to, or equal to the first threshold also falls within the scope of the embodiments.

In another possible implementation, a first constraint condition is that a packet loss rate is greater than a first threshold, and that the network device 1 determines the first queue based on the constraint condition includes: The network device 1 determines, based on the first constraint condition, that a packet loss rate of the first queue is greater than the first threshold. A manner of obtaining the first threshold that is in the first constraint condition is not limited and details are not described herein again. An execution manner in which the network device 1 determines the first queue based on the first constraint condition is not limited. Details are not described herein again. A packet loss rate is a ratio of lost packets to all packets in a queue in the network device 1. The network device 1 determines, based on the first constraint condition, that the packet loss rate of the first queue is greater than the first threshold. For example, if the first threshold is 2%, the first constraint condition is that a packet loss rate is greater than 2%. A packet loss rate of a queue 1 is 3%, and a packet loss rate of a queue 2 is 1%. The network device 1 may determine, based on the first constraint condition, that the packet loss rate 3% of the queue 1 is greater than the first threshold 2%. Additionally, a relationship between the packet loss rate and the first threshold is not limited and details are not described herein again.

In still another possible implementation, a first constraint condition is that an enqueue rate is greater than a first threshold, and that the network device 1 determines the first queue based on the constraint condition includes: The network device 1 determines, based on the first constraint condition, that an enqueue rate of the first queue is greater than the first threshold. A manner of obtaining the first threshold that is in the first constraint condition is not limited and details are not described herein again. An execution manner in which the network device 1 determines the first queue based on the first constraint condition is not limited. Details are not described herein again. An enqueue rate is a rate at which traffic enters a queue of the network device 1. An egress queue is used as an example. Assuming that one port has only one queue, if an enqueue rate is less than a dequeue rate, a queue length is 0; if an enqueue rate is greater than a dequeue rate, packets are stacked in a buffer, and a queue length is greater than 0. The network device 1 determines, based on the first constraint condition, that the enqueue rate of the first queue is greater than the first threshold. For example, if the first threshold is 25 Gigabits per second (Gbps), the first constraint condition is that an enqueue rate is greater than 25 Gbps. An enqueue rate of a queue 1 is 30 Gbps, and an enqueue rate of a queue 2 is 10 Gbps. The network device 1 may determine, based on the first constraint condition, that the enqueue rate 30 Gbps of the queue 1 is greater than the first threshold 25 Gbps. Also, a relationship between the enqueue rate and the first threshold is not limited and details are not described herein again.

In still another possible implementation, a first constraint condition is that a dequeue rate is greater than a first threshold, and that the network device 1 determines the first queue based on the constraint condition includes: The network device 1 determines, based on the first constraint condition, that a dequeue rate of the first queue is greater than the first threshold. A manner of obtaining the first threshold that is in the first constraint condition is not limited and details are not described herein again. An execution manner in which the network device 1 determines the first queue based on the first constraint condition is not limited. Details are not described herein again. A dequeue rate is a rate at which traffic is forwarded. An egress queue is used as an example. Assuming that one port has only one queue, when a queue length is 0, a dequeue rate of the queue is less than a rate limit of the port; or when a queue length is greater than 0, a dequeue rate of the queue is equal to a rate limit of the port. The network device 1 determines, based on the first constraint condition, that the dequeue rate of the first queue is greater than the first threshold. For example, if the first threshold is 25 Gbps, the first constraint condition is that a dequeue rate is greater than 25 Gbps. A dequeue rate of a queue 1 is 30 Gbps, and a dequeue rate of a queue 2 is 10 Gbps. The network device 1 may determine, based on the first constraint condition, that the dequeue rate 30 Gbps of the queue 1 is greater than the first threshold 25 Gbps. A relationship between the dequeue rate and the first threshold is not limited and details are not described herein again.

In still another possible implementation, the constraint condition includes a first constraint condition, the first constraint condition is that a service type of traffic in a queue is a specified service type, and that the network device 1 determines the first queue based on the constraint condition includes: The network device 1 determines, based on the first constraint condition, that a service type of traffic in the first queue is the specified service type. A manner of obtaining the specified service type that is in the first constraint condition is not limited and details are not described herein again. A sequence in which the network device 1 determines the first queue based on the first constraint condition is not limited. Details are not described herein again. A service type is of traffic buffered in a queue, and may be a protocol type of the traffic, for example, the Transmission Control Protocol (TCP) or the User Datagram Protocol (UDP), or may be a service type corresponding to a service identifier carried in the traffic, for example, a service whose TCP packet header carries a URG flag. The network device 1 determines, based on the first constraint condition, that the service type of traffic in the first queue is the specified service type. For example, if the specified service type is a TCP service type, the first constraint condition is that a service type of traffic in a queue is the TCP service type. A packet of the TCP service type exists in a buffer of a queue 1. The network device 1 may determine, based on the first constraint condition, that a service type of traffic in the queue 1 is the specified TCP service type.

Optionally, the constraint condition further includes a second constraint condition, the second constraint condition is that a queue number is equal to a specified queue number, and that the network device 1 determines the first queue based on the constraint condition includes: The network device 1 determines, based on the second constraint condition, that a queue number of the first queue is equal to the specified queue number. A manner of obtaining the specified queue number that is in the second constraint condition is not limited and details are not described herein again. A n execution manner in which the network device 1 determines the first queue based on the second constraint condition is not limited. Details are not described herein again. A queue number is an index of a queue in a network device. Optionally, the queue may alternatively be identified by using a priority of service traffic. The network device 1 determines, based on the second constraint condition, that the queue number of the first queue is equal to the specified queue number. For example, if the specified queue number in the second constraint condition is a queue 1 on a port 10GE ⅟0/1, a queue number of a queue 1 is a queue 1 on the port 10GE ⅟0/1, and a queue number of a queue 2 is a queue 2 on the port 10GE ⅟0/1, the network device 1 may determine, based on the second constraint condition, that the queue 1 is the first queue. Optionally, the second constraint condition may be a constraint condition executed based on the first constraint condition. In other words, the first queue determined based on the second constraint condition also needs to meet the first constraint condition. For example, if the first constraint condition is that a queue length is greater than 20 KB, the specified queue number in the second constraint condition is the queue 1 on the port 10GE ⅟0/1, the queue number of the queue 1 is the queue 1 on the port 10GE ⅟0/1 and a queue length is 25 KB, the queue number of the queue 2 is the queue 1 on the port 10GE ⅟0/1 and a queue length is 0 KB, and a queue number of a queue 3 is a queue 3 on the port 10GE ⅟0/1 and a queue length is 50 KB, the network device 1 may determine, based on the first constraint condition, that the queue 1 and the queue 3 meet the condition, and then determine, based on the second constraint condition, that the queue 1 is the first queue.

Optionally, the first queue may be an egress queue of the network device 1. An egress port is an egress direction of traffic forwarding. The egress port includes a plurality of queues, and may include eight priority queues.

Optionally, the first queue may alternatively be an ingress queue of the network device 1. An ingress port is an ingress direction of traffic forwarding. The ingress port includes a plurality of queues and may include eight priority queues.

S102: The first network device allocates a first storage resource to the first queue, where the first storage resource is used to store visualization information of the first queue, and the visualization information is information used to visualize the first queue.

The visualization information may include at least one of the following information: the queue length, the packet loss rate, the enqueue rate, and the dequeue rate. The network device 1 may allocate the first storage resource to the first queue, and the network device 1 may allocate the storage resource to the first queue based on a size of storage space that needs to be occupied. For example, sizes of the storage space occupied by the visualization information are respectively a queue length (32 bits), a packet loss rate (32 bits), an enqueue rate (32 bits), and a dequeue rate (32 bits), and the network device 1 allocates 4-byte storage space to the first queue. The network device 1 may alternatively allocate the storage resource to the first queue based on a default size of storage space. The default size of the storage space is a preset size of the storage space. The first storage resource may be a storage resource on a chip of the network device 1 or may be an external storage resource of the network device 1.

Optionally, the first queue is an egress queue of the network device 1, the visualization information of the first queue further includes first configuration information, and the first configuration information is configuration information that is configured by the network device 1 on the first queue and that is used to manage the egress queue. The configuration information may be configuration information of a WRED template of the egress queue, and the WRED template includes a maximum threshold MAX_THLD, a minimum threshold MIN_THLD, and a drop probability Drop_Prob. If a queue length of the egress queue exceeds MIN_THLD, packets in the queue start to be discarded at a probability of Drop_Prob. If the queue length exceeds MAX_THLD, all subsequent enqueue packets in the queue are discarded.

Optionally, the first queue is an ingress queue of the network device 1, the visualization information of the first queue further includes first configuration information, and the first configuration information is configuration information that is configured by the network device 1 on the first queue and that is used to manage the ingress queue. The configuration information may be configuration information of a priority-based flow control (PFC) template of the ingress queue, and the PFC template includes a reserved threshold “reserved,” a backpressure frame triggering threshold xoff, and a backpressure frame stop threshold xon.

Optionally, the network device 1 has one common resource pool, and the first storage resource is a storage resource in the common resource pool. Visualization information of all queues that include the ingress queue and the egress queue is stored in the common resource pool.

Optionally, the network device 1 allocates different resource pools to queues of different types. One resource pool is allocated to the ingress queue and another resource pool is allocated to the egress queue.

S103: The first network device generates a first packet, where the first packet includes the visualization information of the first queue.

The first packet may be an Internet Protocol version 6 IPv6) packet, and the visualization information is carried in an extension header. Alternatively, the first packet may be a generic protocol extension for VxLAN (VxLAN-GPE) packet, and the visualization information is carried in a next protocol (next protocol). Alternatively, the first packet may be a generic network virtualization encapsulation (GENEVE) packet, and the visualization information is carried in an option. It should be understood that a protocol format of the first packet is not limited and another protocol packet that can carry the visualization information also falls within the scope of the embodiments. The first packet may carry visualization information of one queue or may carry visualization information of a plurality of queues together.

S104: The first network device sends the first packet to the second network device.

S105: The second network device receives the first packet sent by the first network device, where the first packet includes the visualization information of the first queue, the first queue is a queue that is determined by the first network device based on the constraint condition and that needs to be visualized, and the visualization information is information used to visualize the first queue.

S106: The second network device outputs the visualization information of the first queue.

The network device 4 receives the first packet, parses the visualization information that is in the first packet, and then analyzes and outputs the visualization information. For example, in a network exception alarm, the network device 4 receives the first packet, where the first packet carries the visualization information of the first queue in the network device 1, and the visualization information includes: a queue length 500 KB, a packet loss rate 50%, an enqueue rate 20 Gbps, and a dequeue rate 0. Then, the network device 4 analyzes the visualization information, and finds that the dequeue rate is 0 and the packet loss rate is very high. In this way, the network device 4 infers that a reason of a packet forwarding failure may be a downlink fault of an egress port. Therefore, the network device 4 outputs the received visualization information and an analysis result to a connected screen. Optionally, the visualization information and the analysis result are displayed on the screen in a table as shown in Table 1.

TABLE 1

Visualization information display manner

| Device | Queue | Queue length | Packet loss rate | Enqueue rate | Dequeue rate | Analysis result |
|---|---|---|---|---|---|---|
| Network device 1 | First queue | 500 KB | 50% | 20 Gbps | 0 | Downlink fault |

In an implementation, the network device 1 determines the first queue based on the constraint condition and allocates the first storage resource to the first queue that meets the constraint condition. The first storage resource is used to store the visualization information of the first queue. Therefore, the visualization information of the first queue that is determined based on the constraint condition is stored, a large amount of useless visualization information is not stored, and storage resources for storing the useless visualization information are not allocated, so that occupation of storage resources in the network device is reduced.

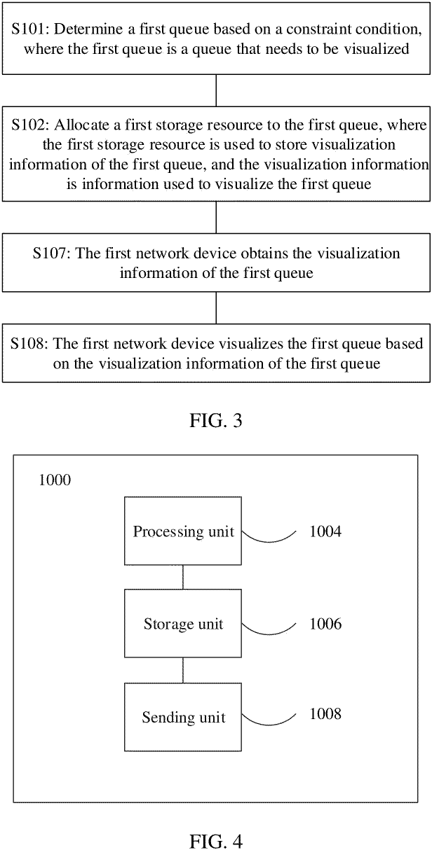

FIG. 3 is another flowchart of visualizing a first queue according to an embodiment. The method shown in FIG. 3 may be applied to the network shown in FIG. 1. In this implementation, an example in which a first network device corresponds to the network device 1 in FIG. 1 is used for description. The method of the first network device may also be applied to the network device 2 and the network device 3, and details are not described herein. The method shown in FIG. 3 includes S101 to S108. S101 and S102 shown in FIG. 3 are the same as S101 and S102 shown in FIG. 2. Details are not described herein again.

S107: The first network device obtains the visualization information of the first queue based on the first storage resource.

The network device 1 may have a visualization function. The network device 1 obtains the visualization information that is of the first queue and that is stored in the first storage resource, and then analyzes and outputs the visualization information.

Optionally, the network device 1 monitors a status of the first storage resource. When the network device 1 finds that the first storage resource is allocated for use, the network device 1 obtains the visualization information stored in the first storage resource. S108: The first network device outputs the visualization information of the first queue.

The network device 1 may be connected to a visual display, and the network device 1 displays, on the visual display, the visualization information in the first storage resource and an analysis result. An analysis manner and a display manner are described in an example in S106.

In an implementation, the network device 1 determines the first queue based on the constraint condition and allocates the first storage resource to the first queue that meets the constraint condition. The first storage resource is used to store the visualization information of the first queue. Therefore, the visualization information of the first queue that is determined based on the constraint condition is stored, a large amount of useless visualization information is not stored, and storage resources for storing the useless visualization information are not allocated, so that occupation of storage resources in the network device is reduced.

FIG. 4 is a schematic diagram of a structure of a first network device 1000 according to an embodiment. The first network device 1000 shown in FIG. 4 may perform corresponding steps that are performed by the first network device in the methods in the foregoing embodiments. As shown in FIG. 4, the first network device 1000 includes a processing unit 1004, a storage unit 1006, and a sending unit 1008. The processing unit 1004 is configured to determine a first queue based on a constraint condition, where the first queue is a queue that needs to be visualized. The processing unit 1004 is further configured to allocate a first storage resource to the first queue, where the first storage resource is used to store visualization information of the first queue, and the visualization information is information used to visualize the first queue. The storage unit 1006 is configured to provide the first storage resource.

In a possible implementation, the constraint condition includes a first constraint condition, the first constraint condition is that a queue length is greater than a first threshold, and that the processing unit 1004 determines a first queue based on a constraint condition includes: The processing unit 1004 determines, based on the first constraint condition, that a queue length of the first queue is greater than the first threshold.

In another possible implementation, the constraint condition includes a first constraint condition, the first constraint condition is that a packet loss rate is greater than a first threshold, and that the processing unit 1004 determines a first queue based on a constraint condition includes: The processing unit 1004 determines, based on the first constraint condition, that a packet loss rate of the first queue is greater than the first threshold.

In still another possible implementation, the constraint condition includes a first constraint condition, the first constraint condition is that an enqueue rate is greater than a first threshold, and that the processing unit 1004 determines a first queue based on a constraint condition includes: The processing unit 1004 determines, based on the first constraint condition, that an enqueue rate of the first queue is greater than the first threshold.

In still another possible implementation, the constraint condition includes a first constraint condition, the first constraint condition is that a dequeue rate is greater than a first threshold, and that the processing unit 1004 determines a first queue based on a constraint condition includes: The processing unit 1004 determines, based on the first constraint condition, that a dequeue rate of the first queue is greater than the first threshold.

In still another possible implementation, the constraint condition includes a first constraint condition, the first constraint condition is that a service type of traffic in a queue is a specified service type, and that the processing unit determines a first queue based on a constraint condition includes: The processing unit 1004 determines, based on the first constraint condition, that a service type of traffic in the first queue is the specified service type.

Optionally, the constraint condition further includes a second constraint condition, the second constraint condition is that a queue number is equal to a specified queue number, and that the processing unit 1004 determines a first queue based on a constraint condition includes: The processing unit 1004 determines, based on the first constraint condition, that a queue number of the first queue is equal to the specified queue number.

Optionally, the visualization information of the first queue includes at least one of the following information: the queue length, the packet loss rate, the enqueue rate, and the dequeue rate.

Optionally, the first queue is an egress queue of the first network device, the visualization information of the first queue further includes first configuration information, and the first configuration information is configuration information that is configured by the first network device on the first queue and that is used to manage the egress queue.

Optionally, the first queue is an ingress queue of the first network device, the visualization information of the first queue further includes first configuration information, and the first configuration information is configuration information that is configured by the first network device on the first queue and that is used to manage the ingress queue.

In a possible implementation, the processing unit 1004 is configured to generate a first packet, where the first packet includes the visualization information of the first queue; and the sending unit 1008 is configured to send the first packet to a second network device.

In another possible implementation, the processing unit 1004 is configured to: obtain the visualization information of the first queue based on the first storage resource, and then output the visualization information of the first queue.

The first network device shown in FIG. 4 may perform corresponding steps that are performed by the first network device in the methods in the foregoing embodiments. In an actual network scenario, the first network device determines the first queue based on the constraint condition and allocates the first storage resource to the queue that meets the constraint condition. The first storage resource is used to store the visualization information of the first queue. Therefore, the visualization information of the first queue is stored, a large amount of useless visualization information is not stored, and storage resources for storing the useless visualization information are not allocated, so that occupation of storage resources in the network device is reduced.

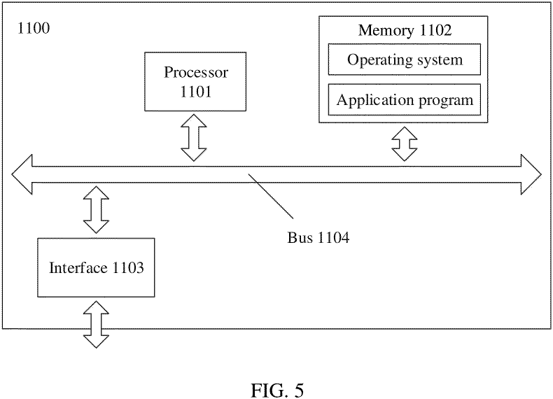

FIG. 5 is a schematic diagram of a hardware structure of a first network device 1100 according to an embodiment. The first network device 1100 shown in FIG. 5 may perform corresponding steps that are performed by the first network device in the methods in the foregoing embodiments.

As shown in FIG. 5, the first network device 1100 includes a processor 1101, a memory 1102, an interface 1103, and a bus 1104. The interface 1103 may be implemented in a wireless or wired manner and may be a network adapter. The processor 1101, the memory 1102, and the interface 1103 are connected through the bus 1104.

The processor 1101 is configured to perform processing performed by the first network device in the foregoing embodiments. For example, the processor 1101 determines a first queue based on a constraint condition, is further configured to allocate a first storage resource to the first queue, and/or is used in another process of the technology described in this specification. For example, the processor 1101 is configured to support the processes S101, S102, S103, S107, and S108 in FIG. 2 and FIG. 3. The memory 1102 includes an operating system 11021 and an application program 11022, and is configured to store a program, code, or instructions. When executing the program, code, or instructions, the processor or a hardware device may complete a processing process of the first network device in the foregoing method embodiments. Optionally, the memory 1102 may include a read-only memory (ROM) and a random access memory (RAM). The ROM includes a basic input/output system (BIOS) or an embedded system. The RAM includes an application program and an operating system. When the first network device 1100 needs to run, the first network device 1100 is started by using a bootloader booting system in the BIOS or the embedded system that is built into the ROM, to boot the first network device 1100 to enter a normal running state. After entering the normal running state, the first network device 1100 runs the application program and the operating system in the RAM, to complete the processing processes related to the first network device in the method embodiments. The interface 1103 may include a transmitter and a receiver and may be configured to send and receive information between the first network device and the second network device in the foregoing embodiments. For example, the interface 1103 is configured to support sending of a first packet. For example, the interface 1103 is configured to support step S104 in FIG. 2.

It may be understood that FIG. 5 shows an embodiment of the first network device 1100. In actual application, the first network device may include any quantity of interfaces, processors, or memories.

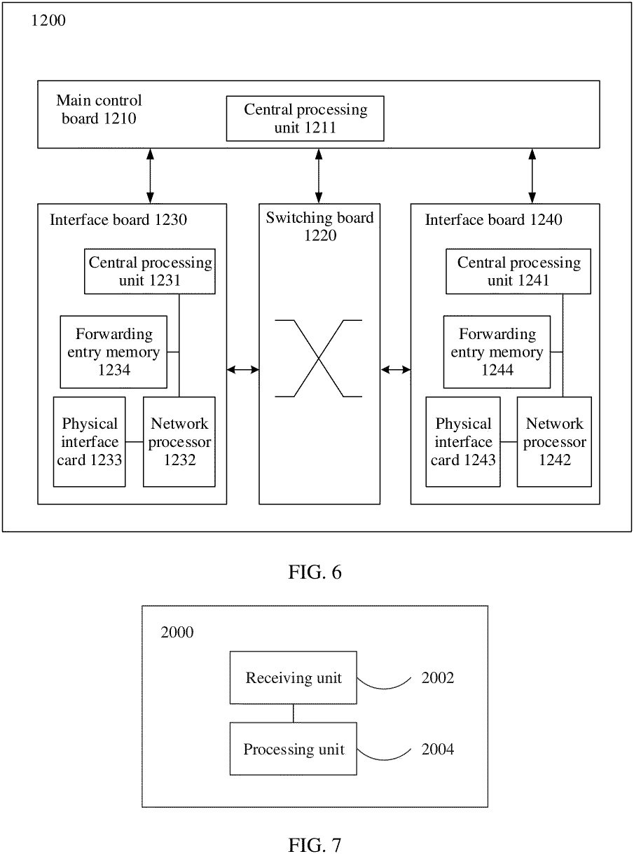

FIG. 6 is a schematic diagram of a hardware structure of another first network device 1200 according to an embodiment. The first network device 1200 shown in FIG. 6 may perform corresponding steps that are performed by the first network device in the methods in the foregoing embodiments.

As shown in FIG. 6, the first network device 1200 includes a main control board 1210, an interface board 1230, a switching board 1220, and an interface board 1240. The main control board 1210, the interface boards 1230 and 1240, and the switching board 1220 are connected to a system backboard through a system bus for communication. The main control board 1210 is configured to complete functions such as system management, device maintenance, and protocol processing. The switching board 1220 is configured to exchange data between the interface boards (where the interface board is also referred to as a line card or a service board). The interface boards 1230 and 1240 are configured to: provide various service interfaces (such as a POS interface, a GE interface, and an ATM interface), and forward a data packet.

The interface board 1230 may include a central processing unit 1231, a forwarding entry memory 1234, a physical interface card 1233, and a network processor 1232. The central processing unit 1231 is configured to: control and manage the interface board and communicate with a central processing unit on the main control board. The forwarding entry memory 1234 is configured to store a forwarding entry. The physical interface card 1233 is configured to receive and send traffic. The network processor 1232 is configured to control, based on the forwarding entry, the physical interface card 1233 to receive and send the traffic.

The physical interface card 1233 may be configured to send a first packet to a second network device.

The central processing unit 1211 is configured to: determine a first queue based on a constraint condition; allocate a first storage resource to the first queue; and obtain visualization information of the first queue based on the first storage resource and output the visualization information.

The central processing unit 1211 is further configured to generate the sent first packet.

The central processing unit 1231 is further configured to control the network processor 1232 to obtain the forwarding entry in the forwarding entry memory 1234, and the central processing unit 1231 is further configured to control the network processor 1232 to receive and send the traffic via the physical interface card 1233.

It should be understood that operations on the interface board 1240 are the same as operations on the interface board 1230 in this embodiment. For brevity, details are not described again. It should be understood that the first network device 1200 in this embodiment may correspond to the functions and/or the various implemented steps in the foregoing method embodiments. Details are not described herein again.

In addition, it should be noted that there may be one or more main control boards, and when there is a plurality of main control boards, the main control boards may include an active main control board and a standby main control board. There may be one or more interface boards, and the first network device with a stronger data processing capability provides more interface boards. There may also be one or more physical interface cards on the interface board. There may be no switching board or one or more switching boards. When there is a plurality of switching boards, load balancing and redundancy backup may be implemented together. In a centralized forwarding architecture, the first network device may not need the switching board, and the interface board implements a service data processing function in an entire system. In a distributed forwarding architecture, the first network device may have at least one switching board, and exchange data between a plurality of interface boards via the switching board, to provide a large-capacity data exchange and processing capability. Therefore, a data access and processing capability of the first network device in the distributed architecture is better than that of the device in the centralized architecture. An architecture that is to be used may depend on a networking deployment scenario. This is not limited herein.

FIG. 7 is a schematic diagram of a structure of a second network device 2000 according to an embodiment. The second network device 2000 shown in FIG. 7 may perform corresponding steps that are performed by the second network device in the methods in the foregoing embodiments. As shown in FIG. 7, the second network device 2000 includes a processing unit 2004 and a receiving unit 2002.

The receiving unit 2002 is configured to receive a first packet sent by a first network device, where the first packet includes visualization information of a first queue, the first queue is a queue that is determined by the first network device based on a constraint condition and that needs to be visualized, and the visualization information is information used to visualize the first queue.

The processing unit 2004 is further configured to output the visualization information of the first queue.

Optionally, the constraint condition includes a first constraint condition, and the first constraint condition includes at least one of the following conditions: a queue length is greater than a first threshold, a packet loss rate is greater than a first threshold, an enqueue rate is greater than a first threshold, a dequeue rate is greater than a first threshold, and a service type of traffic in a queue is a specified service type.

Optionally, the constraint condition further includes a second constraint condition, and the second constraint condition is that a queue number is equal to a specified queue number.

The second network device shown in FIG. 7 may perform corresponding steps that are performed by the second network device in the methods in the foregoing embodiments. In an actual network scenario, the first network device determines the first queue based on the constraint condition and allocates a first storage resource to the queue that meets the constraint condition. The first storage resource is used to store the visualization information of the first queue. Therefore, the visualization information of the first queue is stored, a large amount of useless visualization information is not stored, and storage resources for storing the useless visualization information are not allocated, so that occupation of storage resources in the network device is reduced.

FIG. 8 is a schematic diagram of a hard structure of a second network device 2100 according to an embodiment. The second network device 2100 shown in FIG. 8 may perform corresponding steps that are performed by the second network device in the methods in the foregoing embodiments.

As shown in FIG. 8, the second network device 2100 includes a processor 2101, a memory 2102, an interface 2103, and a bus 2104. The interface 2103 may be implemented in a wireless or wired manner and may be a network adapter. The processor 2101, the memory 2102, and the interface 2103 are connected through the bus 2104.

The interface 2103 may include a transmitter and a receiver and may be configured to send and receive information between the second network device and the first network device in the foregoing embodiments. For example, the interface 2103 is configured to support receiving of a first packet sent by the first network device. For example, the interface 2103 is configured to support the S105 process in FIG. 2. The processor 2101 is configured to perform processing performed by the second network device in the foregoing embodiments. For example, the processor 2101 is configured to output visualization information of a first queue. For example, the processor 2101 is configured to support the S106 process in FIG. 2. The memory 2102 includes an operating system 21021 and an application program 21022, and is configured to store a program, code, or instructions. When executing the program, code, or instructions, the processor or a hardware device may complete a processing process of the second network device in the foregoing method embodiments. Optionally, the memory 2102 may include a read-only memory (ROM) and a random access memory (RAM). The ROM includes a basic input/output system (BIOS) or an embedded system. The RAM includes an application program and an operating system. When the second network device 2100 needs to run, the second network device is started by using a bootloader booting system in the BIOS or the embedded system that is built into the ROM, to boot the second network device 2100 to enter a normal running state. After entering the normal running state, the second network device 2100 runs the application program and the operating system in the RAM, to complete the processing processes related to the second network device in the method embodiments.

It may be understood that FIG. 8 shows an embodiment of the second network device 2100. In actual application, the second network device may include any quantity of interfaces, processors, or memories.

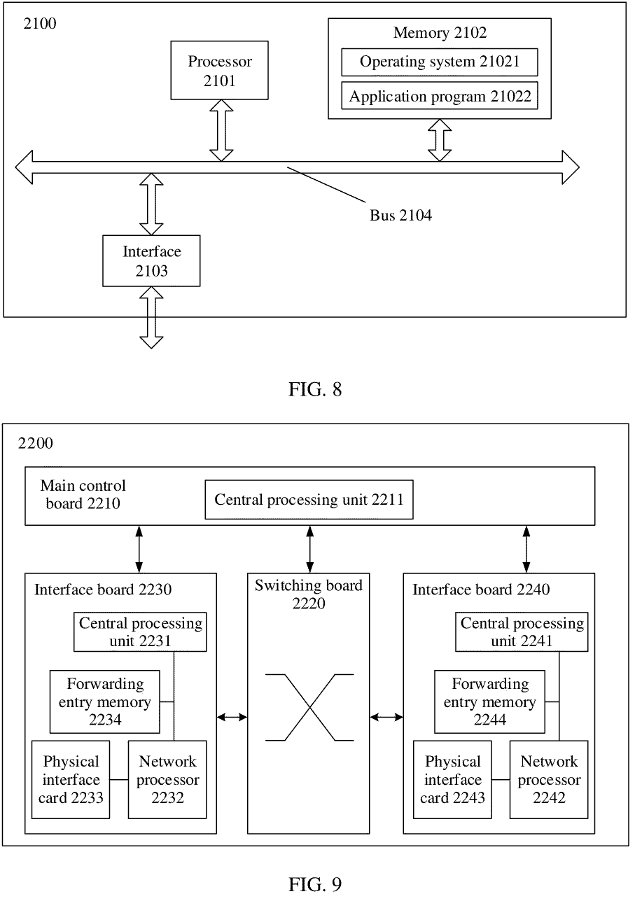

FIG. 9 is a schematic diagram of a hardware structure of another second network device 2200 according to an embodiment. The second network device 2200 shown in FIG. 9 may perform corresponding steps that are performed by the second network device in the methods in the foregoing embodiments.

As shown in FIG. 9, the second network device 2200 includes a main control board 2210, an interface board 2230, a switching board 2220, and an interface board 2240. The main control board 2210, the interface boards 2230 and 2240, and the switching board 2220 are connected to a system backboard through a system bus for communication. The main control board 2210 is configured to complete functions such as system management, device maintenance, and protocol processing. The switching board 2220 is configured to exchange data between interface boards (where the interface board is also referred to as a line card or a service board). The interface boards 2230 and 2240 are configured to: provide various service interfaces (such as a POS interface, a GE interface, and an ATM interface), and forward a data packet.

The interface board 2230 may include a central processing unit 2231, a forwarding entry memory 2234, a physical interface card 2233, and a network processor 2232. The central processing unit 2231 is configured to: control and manage the interface board and communicate with a central processing unit on the main control board. The forwarding entry memory 2234 is configured to store a forwarding entry. The physical interface card 2233 is configured to receive and send traffic. The network processor 2232 is configured to control, based on the forwarding entry, the physical interface card 2233 to receive and send the traffic.

The physical interface card 2233 may be configured to receive a first packet sent by a first network device. The central processing unit 2211 may be configured to process the received first packet.

The central processing unit 2211 is configured to output visualization information of a first queue.

The central processing unit 2231 is further configured to control the network processor 2232 to obtain the forwarding entry in the forwarding entry memory 2234, and the central processing unit 2231 is further configured to control the network processor 2232 to receive and send the traffic via the physical interface card 2233.

It should be understood that operations on the interface board 2240 are the same as operations on the interface board 2230 in this embodiment. For brevity, details are not described again. It should be understood that the second network device 2200 in this embodiment may correspond to the functions and/or the various implemented steps in the foregoing method embodiments. Details are not described herein again.

In addition, it should be noted that there may be one or more main control boards, and when there is a plurality of main control boards, the main control boards may include an active main control board and a standby main control board. There may be one or more interface boards, and the second network device with a stronger data processing capability provides more interface boards. There may also be one or more physical interface cards on the interface board. There may be no switching board or one or more switching boards. When there is a plurality of switching boards, load balancing and redundancy backup may be implemented together. In a centralized forwarding architecture, the second network device may not need the switching board, and the interface board implements a service data processing function in an entire system. In a distributed forwarding architecture, the second network device may have at least one switching board, and exchange data between a plurality of interface boards via the switching board, to provide a large-capacity data exchange and processing capability. Therefore, a data access and processing capability of the second network device in the distributed architecture is better than that of the device in the centralized architecture. An architecture that is to be used may depend on a networking deployment scenario. This is not limited herein.

In addition, an embodiment may provide a non-transitory computer storage medium, configured to store computer software instructions used by the foregoing first network device. The non-transitory computer storage medium may include a program for executing the foregoing method embodiments.

In addition, an embodiment may provide a non-transitory computer storage medium, configured to store computer software instructions used by the foregoing second network device. The non-transitory computer storage medium may include a program for executing the foregoing method embodiments.

An embodiment may further include a communication system. The system includes a first network device and a second network device. The first network device is the first network device in FIG. 4, FIG. 5, or FIG. 6, and the second network device is the second network device in FIG. 7, FIG. 8, or FIG. 9.

Method or algorithm steps described in combination with the content of the embodimentsmay be implemented by hardware or may be implemented by a processor by executing software instructions. The software instructions may include a corresponding software module. The software module may be stored in a RAM memory, a flash memory, a ROM memory, an EPROM memory, an EEPROM memory, a register, a hard disk, a removable hard disk, a CD-ROM memory, or a storage medium in any other form well-known in the art. For example, a storage medium is coupled to a processor, so that the processor can read information from the storage medium or write information into the storage medium. Additionally, the storage medium may be a component of the processor. The processor and the storage medium may be disposed in an ASIC. In addition, the ASIC may be located in user equipment. Further, the processor and the storage medium may exist in the user equipment as discrete components.

A person skilled in the art should be aware that in the foregoing one or more examples, functions may be implemented by hardware or a combination of hardware and software. When the functions are implemented by the combination of hardware and software, the software may be stored in a computer-readable medium or transmitted as one or more instructions or code in the computer-readable medium. The computer-readable medium includes a computer storage medium and a communication medium, where the communication medium includes any medium that enables a computer program to be transmitted from one place to another. The storage medium may be any available medium accessible to a general-purpose or a dedicated computer.

The objectives, solutions, and beneficial effects are further described in detail in the foregoing implementations. It should be understood that the foregoing descriptions are embodiments and non-limiting.

1. A method for allocating a resource for storing visualization information, the method
determining, by a first network device, a first queue based on a constraint condition, wherein the first queue is a queue that needs to be visualized; and
allocating, by the first network device, a first storage resource to the first queue, wherein the first storage resource is used to store visualization information of the first queue, and the visualization information is information used to visualize the first queue.

2. The method according to claim 1, wherein the constraint condition comprises a first constraint condition, the first constraint condition is that a queue length is greater than a first threshold, and the-determining, by the first network device, the first queue based on the constraint condition further comprises:
determining, by the first network device, that a queue length of the first queue is greater than the first threshold based on the first constraint condition.

3. The method according to claim 1, wherein the constraint condition comprises a first constraint condition, the first constraint condition is that a packet loss rate is greater than a first threshold, and determining, by the first network device, the first queue based on the constraint condition further comprises:
determining, by the first network device, that a packet loss rate of the first queue is greater than the first threshold based on the first constraint condition.

4. The method according to claim 1, wherein the constraint condition comprises a first constraint condition, the first constraint condition is that an enqueue rate is greater than a first threshold, and the-determining, by the first network device, the first queue based on the constraint condition further comprises:
determining, by the first network device, that an enqueue rate of the first queue is greater than the first threshold based on the first constraint condition.

5. The method according to claim 1, wherein the constraint condition comprises a first constraint condition, the first constraint condition is that a dequeue rate is greater than a first threshold, and determining, by the first network device, the first queue based on the constraint condition further comprises:
determining, by the first network device, that a dequeue rate of the first queue is greater than the first threshold based on the first constraint condition.

6. The method according to claim 1, wherein the constraint condition comprises a first constraint condition, the first constraint condition is that a service type of traffic in a queue is a specified service type, and determining, by the first network device, the first queue based on the constraint condition further comprises:
determining, by the first network device that a service type of traffic in the first queue is the specified service type based on the first constraint condition.

7. The method according to claim 1, wherein the constraint condition comprises a second constraint condition, the second constraint condition is that a queue number is equal to a specified queue number, and determining, by the first network device, the first queue based on the constraint condition further comprises:
determining, by the first network device, that a queue number of the first queue is equal to the specified queue number based on the second constraint condition.

8. The method according to claim 1, wherein the visualization information of the first queue comprises at least one of the following the queue length, the packet loss rate, the enqueue rate, or the dequeue rate.

9. The method according to claim 8, wherein the first queue is an egress queue of the first network device, the visualization information of the first queue further comprises first configuration information, and the first configuration information is configuration information that is configured by the first network device on the first queue and that is used to manage the egress queue.

10. The method according to claim 8, wherein the first queue is an ingress queue of the first network device, the visualization information of the first queue further comprises first configuration information, and the first configuration information is configuration information that is configured by the first network device on the first queue and that is used to manage the ingress queue.

11. The method according to claim 1, further comprising:
generating, by the first network device, a first packet, wherein the first packet comprises the visualization information of the first queue; and
sending, by the first network device, the first packet to a second network device.

12. The method according to claim 1, further comprising:
obtaining, by the first network device, the visualization information of the first queue based on the first storage resource; and
outputting, by the first network device, the visualization information of the first queue.

13. A first network device comprising:
a memory comprising instructions;
a processor coupled to the memory, wherein when the instructions are is-executed by the processor, cause the first network device to:
determine a first queue based on a constraint condition, wherein the first queue is a queue that needs to be visualized;
allocate a first storage resource to the first queue, wherein the first storage resource is used to store visualization information of the first queue, and the visualization information is information used to visualize the first queue.

14. The first network device according to claim 13, wherein the constraint condition comprises a first constraint condition, the first constraint condition is that a queue length is greater than a first threshold, and the instructions further cause the first network device to:
determine, that a queue length of the first queue is greater than the first threshold based on the first constraint condition.

15. The first network device according to claim 14, wherein the constraint condition further comprises a second constraint condition, the second constraint condition is that a queue number is equal to a specified queue number, and the instructions further cause the first network device to:
determine, -that a queue number of the first queue is equal to the specified queue number based on the second constraint condition.

16. The first network device according to claim 13, wherein the visualization information of the first queue comprises at least one of the following the queue length, a packet loss rate, an enqueue rate, or a dequeue rate.

17. The first network device according to claim 16, wherein the first queue is an egress queue of the first network device, the visualization information of the first queue further comprises first configuration information, and the first configuration information is configuration information that is configured by the first network device on the first queue and that is used to manage the egress queue.

18. The first network device according to claim 13, wherein the instructions further cause the first network device to:
generate a first packet, wherein the first packet comprises the visualization information of the first queue; and
send the first packet to a second network device.

19. The first network device according to claim 13, wherein the instructions further cause the first network device to:
obtain the visualization information of the first queue based on the first storage resource; and
output the visualization information of the first queue.

20. A non-transitory computer-readable storage medium, wherein the non-transitory computer-readable storage medium stores instructions, and when the instructions are run on a processor, a network device is enabled to perform:
determine a first queue based on a constraint condition, wherein the first queue is a queue that needs to be visualized;
allocate a first storage resource to the first queue, wherein the first storage resource is used to store visualization information of the first queue, and the visualization information is information used to visualize the first queue.
